(19) United States
(12) Patent Application Publication
(10) Pub. No.: US 2020/0041459 A1
(43) Pub. Date: Feb. 6, 2020

(54) CAPACITIVE TRANSDUCER AND ULTRASONIC PROBE USING SAME

(71) Applicant: CANON KABUSHIKI KAISHA, Tokyo (JP)

(72) Inventor: Ayako Maruyama, Kawasaki-shi (JP)

(21) Appl. No.: 16/523,724

(22) Filed: Jul. 26, 2019

(30) Foreign Application Priority Data
Jul. 31, 2018 (JP) 2018-143723

(51) Int. Cl. G01N 29/24; B06B 1/02

(52) U.S. Cl. CPC G01N 29/2406; G01N 29/2418; B06B 1/0207

(57) ABSTRACT

A capacitive transducer includes an element including a plurality of cells. Each of the cells includes a first electrode and a vibrating membrane including a second electrode opposed to the first electrode via a gap. The second electrode of one of the plurality of cells is electrically connected to the second electrode of at least one adjoining cell by first electrical wiring. The first electrical wiring over the gap of a first cell provided on a periphery of the element among the plurality of cells has a structure different from that of the first electrical wiring over the gap of a second cell provided on an inner side of the element than the first cell is.

### BACKGROUND

### Field

One disclosed aspect of the embodiments relates to a capacitive transducer and an ultrasonic probe using the same.

### Description of the Related Art

Micro mechanical members manufactured with micromachining techniques are capable of micrometer-order machining, and various micro functional devices have conventionally been fabricated with micro mechanical members. Capacitive transducers with such techniques have been studied as an alternative to piezo elements. Capacitive transducers may hereinafter be referred to as capacitive micromachined ultrasound transducers (CMUTs). With such CMUTs, acoustic waves (typically, ultrasonic waves) can be transmitted and received by using the vibration of vibrating membranes. Excellent wideband characteristics can easily be obtained in liquids in particular.

Japanese Patent No. 06189167 discusses an ultrasonic diagnostic apparatus that transmits ultrasonic waves from a CMUT to a subject, receives ultrasonic waves from the subject by the CMUT, and generates an ultrasound image based on a reception signal output from the CMUT. The CMUT discussed in Japanese Patent No. 06189167 includes a plurality of cells in each of which a vibrating membrane including one of a pair of electrodes formed across a gap is supported to be able to vibrate. The cells are electrically connected to each other by wiring.

According to Japanese Patent No. 06189167, the wiring electrically connecting the cells has a uniform width at any position.

It has been found that the amplitude and phase of the vibrating membranes vary depending on where the cells are located within the element. In particular, the amplitude of the vibrating membranes has been found to increase in cells arranged on a periphery of the element since such cells undergo less interaction from surrounding cells. The reason is considered to be that if a plurality of cells is arranged to transmit or receive acoustic waves, the vibrations of the respective cells interact (cause acoustic interactions) with each other via the medium on the vibrating membranes. The increased amplitude of the vibrating membranes can lower the durability of the wiring connecting the electrodes constituting such cells compared with other cells, and can lower the reliability of the CMUT.

In addition, if the vibrating membranes of the cells arranged on the periphery of the element have an amplitude greater than that of the vibrating membranes of the cells provided on an inner side, side lobes can occur.

### SUMMARY

One aspect of the embodiments is directed to providing a configuration for solving issues resulting from a difference in the amplitude of vibrating membranes of cells between the periphery and inner side of an element included in a capacitive micromachined ultrasound transducer (CMUT).

According to an aspect of the embodiments, a capacitive transducer includes an element including a plurality of cells. Each of the cells includes a first electrode and a vibrating membrane including a second electrode opposed to the first electrode via a gap. The second electrode of one of the plurality of cells is electrically connected to the second electrode of at least one adjoining cell by first electrical wiring. The first electrical wiring over the gap of a first cell provided on a periphery of the element among the plurality of cells has a structure different from that of the first electrical wiring over the gap of a second cell provided on an inner side of the element than the first cell is.

Further features of the disclosure will become apparent from the following description of exemplary embodiments with reference to the attached drawings.

### BRIEF DESCRIPTION OF THE DRAWINGS

FIG. 1 is an enlarged partial top view for describing a capacitive micromachined ultrasound transducer (CMUT) according to an exemplary embodiment.

FIG. 2 is an overall view of FIG. 1 for describing the CMUT according to the exemplary embodiment.

FIG. 3 is a sectional view for describing the CMUT according to the exemplary embodiment of the present invention, taken along the line A-B of FIG. 1.

FIG. 4 illustrates an example of the CMUT according to the exemplary embodiment.

FIG. 5 illustrates an example of the CMUT according to the exemplary embodiment.

FIGS. 6A to 6G are sectional views for describing a method for manufacturing the CMUT according to the exemplary embodiment, taken along the line A-B of FIG. 1.

FIG. 7 illustrates an example of a driving apparatus for the CMUT according to the exemplary embodiment.

FIG. 8 illustrates an example of a transmission and reception circuit of the CMUT according to the exemplary embodiment.

FIG. 9 illustrates an example of an ultrasonic probe according to the exemplary embodiment.

FIG. 10 is a graph illustrating a relationship between a width 18 of first electrical wiring 13 arranged on a vibrating membrane 17 of a cell 2 constituting a periphery of an element 3 and a pull-in voltage according to an exemplary embodiment.

FIG. 11 is a graph illustrating a relationship between the height of a gap 9 and the width 18 of the first electrical wiring 13 arranged on the vibrating membrane 17 according to the exemplary embodiment where the pull-in voltage is 81 V.

FIG. 12 illustrates an example of a sectional structure of a CMUT according to an exemplary embodiment.

FIG. 13 is a graph illustrating a relationship between a thickness 19 of first electrical wiring 13 arranged on a vibrating membrane 17 of a cell 2 constituting a periphery of an element 3 and a pull-in voltage according to the exemplary embodiment.

FIG. 14 is a graph illustrating a relationship of the thickness of a second electrode 11 of the cell 2 constituting the periphery of the element 3 and the thickness 19 of the first electrical wiring 13 arranged on the vibrating membrane 17 to the pull-in voltage according to the exemplary embodiment.

FIG. 15 is a graph illustrating a relationship of the height of a gap 9 to the thickness of the second electrode 11 and the thickness 19 of the first electrical wiring 13 arranged on the vibrating membrane 17 according to the exemplary embodiment where the pull-in voltage is 81 V.

FIG. 16 is a graph illustrating a relationship between the Young's modulus of first electrical wiring 13 arranged on a vibrating membrane 17 of a cell 2 constituting a periphery of an element 3 and a pull-in voltage according to an exemplary embodiment.

FIG. 17 is a graph illustrating a relationship of the Young's modulus of a second electrode 11 of the cell 2 constituting the periphery of the element 3 and the Young's modulus of the first electrical wiring 13 arranged on the vibrating membrane 17 to the pull-in voltage according to the exemplary embodiment.

### DESCRIPTION OF THE EMBODIMENTS

Capacitive micromachined ultrasound transducers (CMUTs) according to an exemplary embodiment will be described, whereas the disclosure is not limited thereto. A CMUT according to the present exemplary embodiment includes an element including a plurality of cells. The cells each include a first electrode and a vibrating membrane including a second electrode opposed to the first electrode via a gap. The second electrode of one of the plurality of cells is electrically connected to the second electrode of at least one adjoining cell by first electrical wiring. The first electrical wiring over the gap of a first cell provided on a periphery of the element among the plurality of cells has a structure (physical property) different from that of the first electrical wiring over the gap of a second cell provided on an inner side of the element than the first cell is. With such a configuration, issues resulting from a difference in the amplitude of the vibrating membranes of the cells between the periphery and inner side of the element included in the CMUT can be solved. For example, as described above, the vibrating membranes of peripheral cells have a large amplitude and are likely to degrade, compared with those of inner cells. Thus, durability is increased to suppress degradation by configuring the first electrical wiring over the gap of the first cell provided on the periphery of the element among the plurality of cells to have a fatigue limit higher than that of the first electrical wiring over the gap of the second cell provided on the inner side of the element than the first cell is. The fatigue limit is defined in Japanese Industrial Standards (JIS) Z 2273. Cells provided on the periphery of the element refer to ones located at the outer rims of an element area formed by a cell array. In the case of a one- or two-column cell array, cells provided on the periphery of the element refer to ones located at ends.

Examples of means for increasing the fatigue limit include increasing the width of the first electrical wiring, increasing the thickness of the first electrical wiring, increasing the Young's modulus of the first electrical wiring, and increasing the stress of the first electrical wiring. More specifically, the durability can be improved by configuring the first electrical wiring over the gap of the first cell provided on the periphery of the element among the plurality of cells to have a width greater than that of the first electrical wiring over the gap of the second cell provided on the inner side of the element than the first cell is. The durability can also be improved by configuring the first electrical wiring over the gap of the first cell provided on the periphery of the element among the plurality of cells to have a thickness greater than that of the first electrical wiring over the gap of the second cell provided on the inner side of the element than the first cell is. The durability can also be improved by configuring the second electrode of the first cell provided on the periphery of the element among the plurality of cells to have a thickness greater than that of the second electrode of the second cell provided on the inner side of the element than the first cell is. The durability can also be improved by configuring the first electrical wiring over the gap of the first cell provided on the periphery of the element among the plurality of cells to have a Young's modulus higher than that of the first electrical wiring over the gap of the second cell provided on the inner side of the element than the first cell is. The durability can also be improved by configuring the second electrode of the first cell provided on the periphery of the element among the plurality of cells to have a Young's modulus higher than that of the second electrode of the second cell provided on the inner side of the element than the first cell is.

The material of the first electrical wiring over the gap of the first cell provided on the periphery of the element among the plurality of cells may have a fatigue limit higher than that of the material of the first electrical wiring over the gap of the second cell provided on the inner side of the element than the first cell is. Such means for improving durability each may be employed by itself. A plurality of means may be employed.

Aside from the durability issue, side lobes may occur if the amplitude of the vibrating membranes of cells arranged on the periphery of the element is greater than that of the vibrating membranes of cells arranged on the inner side. Side lobes can be suppressed by configuring the first electrical wiring over the gap of the first cell provided on the periphery of the element among the plurality of cells to have a structure different from that of the first electrical wiring over the gap of the second cell provided on the inner side of the element than the first cell is. For example, the first electrical wiring over the gap of the first cell provided on the periphery of the element among the plurality of cells may have a thickness different from that of the first electrical wiring over the gap of the second cell provided on the inner side of the element than the first cell is. The second electrode of the first cell provided on the periphery of the element among the plurality of cells may have a thickness different from that of the second electrode of the second cell provided on the inner side of the element than the first cell is. The first electrical wiring over the gap of the first cell provided on the periphery of the element among the plurality of cells may have a Young's modulus different from that of the first electrical wiring over the gap of the second cell provided on the inner side of the element than the first cell is. The second electrode of the first cell provided on the periphery of the element among the plurality of cells may have a Young's modulus different from that of the second electrode of the second cell provided on the inner side of the element than the first cell is. The first electrical wiring over the gap of the first cell provided on the periphery of the element among the plurality of cells may be made of a material different from that of the first electrical wiring over the gap of the second cell provided on the inner side of the element than the first cell is. The first electrical wiring over the gap of the first cell provided on the periphery of the element among the plurality of cells may have a stress different from that of the first electrical wiring over the gap of the second cell provided on the inner side of the element than the first cell is.

In the foregoing configurations, it is desirable that the pull-in voltage of the first cell provided on the periphery of the element is made substantially the same as that of the second cell provided on the inner side of the element than the first cell is. The reason is that such a configuration can reduce differences between the ultrasonic transmission and reception characteristics of the cells.

(Ultrasonic Probe)

An ultrasonic probe according to the present exemplary embodiment includes the foregoing CMUT according to the present exemplary embodiment, a detection unit that detects ultrasonic waves generated by irradiation of a subject with ultrasonic waves and outputs a signal, and an acquisition unit that obtains information about the subject based on the signal.

(Photoacoustic Apparatus)

A photoacoustic apparatus according to the present exemplary embodiment includes the foregoing CMUT according to the present exemplary embodiment, a detection unit that detects ultrasonic waves generated by irradiation of a subject with light and outputs a signal, and an acquisition unit that obtains information about the subject based on the signal.

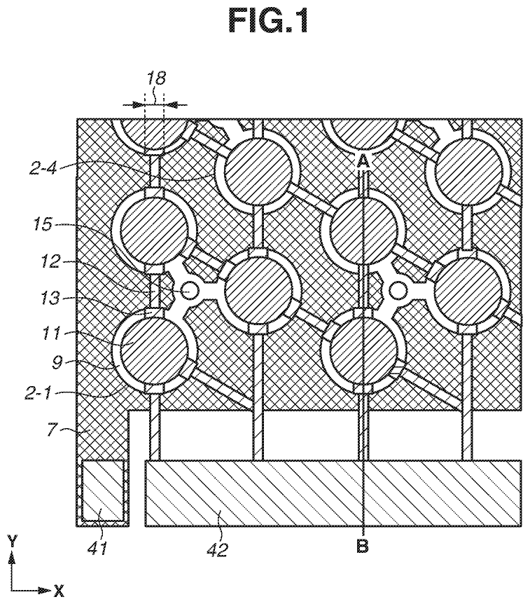

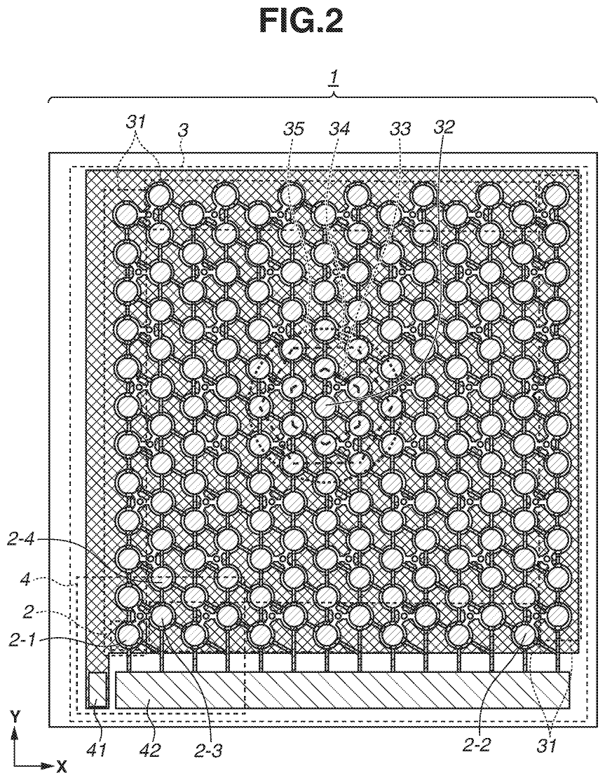

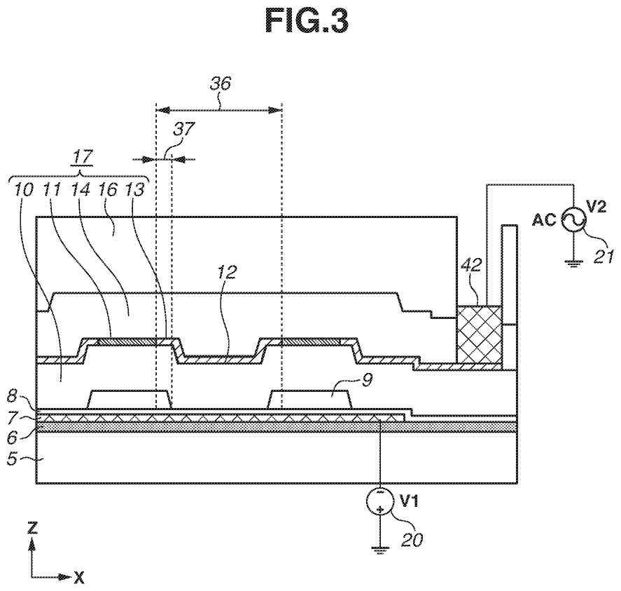

An exemplary embodiment will be described in detail below with reference to FIGS. 1 to 3. FIG. 1 is an enlarged partial top view of a capacitive transducer (CMUT) 1 according to the present exemplary embodiment. FIG. 2 is an overall view of FIG. 1. FIG. 3 is a sectional view taken along the line A-B of FIG. 1. In FIGS. 1 and 2, a second insulation film 8, a third insulation film 10, a fourth insulation film 14, and a sealing film 16 are omitted. In FIG. 2, an area 4 represents the portion enlarged in FIG. 1. A cell 2-1 corresponds to the foregoing first cell, and a cell 2-4 the foregoing second cell. As illustrated in FIG. 3, vibrating membranes 17 are provided over gaps 9. The vibrating membranes 17 are not illustrated in FIGS. 1 and 2. As illustrated in FIG. 2, an element 3 includes a plurality of cells 2. The CMUT 1 includes a plurality of elements 3.

In the present exemplary embodiment, first electrical wiring 13 arranged on the vibrating membranes 17 differs between the periphery and inner side of the element 3.

The CMUT 1 illustrated in FIGS. 1 and 2 includes an element 3 including cells 2. The cells 2 each include a first electrode 7 formed on a support substrate 5, and a vibrating membrane 17 that includes a second electrode 11 opposed to the first electrode 7 via a gap 9 and is supported to be able to vibrate. While FIG. 2 illustrates only one element 3, the CMUT 1 may include any number of elements 3. The element 3 includes 168 cells 2, whereas the element 3 may include any number of cells 2. The cells 2 may be arranged in any pattern, including a grid pattern and a staggered pattern. The general outer shape of the element 3 is not limited to rectangular as illustrated in FIG. 2, and may be square, oblong rectangular, hexagonal, trapezoidal, polygonal, or circular.

As illustrated in FIGS. 1 and 3, each cell 2 includes the substrate 5, a first insulation film 6 formed on the substrate 5, the first electrode 7 formed on the first insulation film 6, and a second insulation film 8 formed on the first electrode 7. A vibrating membrane 17 includes a third insulation film 10, a second electrode 11, first electrical wiring 13 arranged on the vibrating membrane 17, a fourth insulation film 14, and a sealing film 16. There is a gap 9 under the vibrating membrane 17.

As will be described below, gaps 9 are formed by etching a sacrifice layer via etching holes 15. The second insulation film 8 is provided for the purpose of improving the withstand voltage of the cells 2 and preventing buildup of charge on the third insulation film. The second insulation film 8 may therefore be omitted if not needed. The fourth insulation film 14 is provided for the purpose of controlling deformation of the gaps 9 after the etching of the sacrifice layer. The fourth insulation film 14 may be omitted if not needed. The sealing film 16 is provided for the purposes of controlling deformation of the vibrating membranes 17 and sealing the gaps 9. The sealing film 16 may be omitted if not needed. When seen from the top surface, the gaps 9 have a circular shape and the vibrating portions have a circular shape. The shapes may be square, rectangular, hexagonal, trapezoidal, or polygonal. The second electrode 11 of a cell 2 is connected to that of at least one adjoining cell 2 via first electrical wiring 12. The first electrical wiring 12 includes the first electrical wiring 13 arranged on the vibrating membranes 17. As illustrated in FIG. 3, the CMUT 1 further includes a first voltage application unit 20 that applies a voltage across the first electrode 7 and the second electrodes 11 of the cells 2, and a second voltage application unit 21 that applies a transmission drive voltage to the second electrodes 11.

The CMUT 1 according to the present exemplary embodiment can apply a bias voltage to the first electrode 7 by the first voltage application unit 20. If the bias voltage is applied to the first electrode 7, a potential difference occurs between the first electrode 7 and the second electrodes 11. The potential difference displaces the vibrating membranes 17 up to where the resilience of the vibrating membranes 17 balances with the electrostatic attraction. If, in such a state, ultrasonic waves reach the vibrating membranes 17, the vibrating membranes 17 vibrate to change the capacitances between the first electrode 7 and the second electrodes 11, and a current flows through the second electrodes 11. The current is taken out via a second electrode pad 42 lead out from the second electrodes 11, whereby the ultrasonic waves can be taken out as an electrical signal.

Ultrasonic waves can be transmitted by applying the transmission drive voltage from the second voltage application unit 21 to the second electrodes 11 in the state where the bias voltage is applied to the first electrode 7 by the first voltage application unit 20. The transmission drive voltage may have any waveform as long as desired ultrasonic waves can be transmitted by that waveform. Desired waveforms may be used, including a unipolar pulse, a bipolar pulse, burst waves, and continuous waves.

If the voltage applied to the first electrode 7 increases, the electrostatic attraction exceeds the resilience of the vibrating membranes 17, and the vibrating membranes 17 come into contact with the second insulation film 8 at the bottom of the gaps 9. Such a voltage will be referred to as a pull-in voltage. The higher the ratio of the bias voltage to the pull-in voltage, the higher the conversion efficiency with which received acoustic waves are converted into an electrical signal or an electrical signal is converted into acoustic waves. If a voltage higher than or equal to the pull-in voltage is applied between the electrodes 7 and 11, the vibrating membranes 17 come into contact with the bottom of the gaps 9 to greatly change the frequency characteristics of the element 3. This causes a significant change in the reception sensitivity for detectable acoustic waves. The intensity and frequency characteristics of transmittable acoustic waves also vary greatly. The pull-in voltages of the cells 2 included in the CMUT 1 is therefore substantially the same, desirably.

As illustrated in FIG. 2, if the CMUT 1 transmits or receives acoustic waves, the vibrations of the vibrating membranes 17 in the respective cells 2 interact (cause acoustic interactions) with each other via a medium on the vibrating membranes 17. The amplitude and phase of the vibrating membranes 17 vary depending on where the cells 2 are located within the element 3. In particular, the cells 2 arranged on the periphery and sides of the element 3 undergo less interaction from surrounding cells 2, and the amplitude of the vibrating membranes 17 increases. The increased amplitude of the vibrating membranes 17 can lower the durability of the first electrical wiring 13 that is arranged on the vibrating membranes 17 and connects the second electrodes 11 included in such cells 2, compared with other cells 2. This lowers the durability and reliability of the CMUT 1. In the present exemplary embodiment, the durability and reliability of the CMUT 1 are improved by configuring the first electrical wiring 13 arranged on the vibrating membranes 17 differently between the inner side and periphery of the element 3. For example, in FIG. 2, the cells 2 surrounded by long broken lines 31 indicating peripheral cells are the cells 2 arranged on the periphery of the element 3. The other cells 2 are inner cells. Like the ones surrounded by the long broken lines 31 indicating peripheral cells illustrated in FIG. 2, a cell 2 arranged on the periphery of the element 3 refers to one that adjoins fewer cells 2 at a closest distance than the maximum number of cells 2 to adjoin at the closest distance. For example, in FIG. 2, the maximum number of cells 2 to adjoin at the closest distance is six. Cells 2 to which a cell 32 adjoins at the closest distance will be called first adjacent cells 33. The first adjacent cells 33 refer to the cells 2 the centers of which are connected by a broken line 33 in FIG. 2. The distances from the centers of the respective first adjacent cells 33 to the center of the cell 32 are the same. All the cells 2 other than those surrounded by the long broken lines 31 indicating peripheral cells adjoin six first adjacent cells 33. The number of cells 2 that the cell 2-1 arranged at the bottom left of the element 3 in FIG. 2 adjoins at the closest distance is two. The number of cells 2 that a cell 2-2 arranged at the bottom right of the element 3 in FIG. 2 adjoins at the closest distance is three. The number of cells 2 that a cell 2-3 of the element 3 in FIG. 2 adjoins at the closest distance is five. In other words, cells 2 that do not have six first adjacent cells 33 are the peripheral cells 2 of the element 3. Not only cells 2 having fewer first adjacent cells 33 but ones having fewer next-adjacent, second adjacent cells 34 than a maximum number may also be referred to as peripheral cells 2. Given a cell 32, second adjacent cells 34 refer to the cells 2 the centers of which are connected by a broken line 34 in FIG. 2. The distances from the centers of the respective second adjacent cells 34 to the center of the cell 32 are the same. The maximum number of cells 2 that are second adjacent cells 34 is six. For example, the number of cells 2 that are second adjacent cells 34 to the cell 2-4 of the element 3 in FIG. 2 is five. In other words, the cell 2-4 is also a cell 2 arranged on the periphery of the element 3. Similarly, cells 2 having fewer third adjacent cells 35 outside the second adjacent cells 34 may be also be referred to as cells 2 arranged on the periphery of the element 3. Third adjacent cells 35 refer to the cells 2 the centers of which are connected by a broken line 35 in FIG. 2. The distances from the centers of the respective third adjacent cells 35 to the center of the cell 32 are the same. Cells 2 having fewer cells 2 constituting first adjacent cells 33 in particular undergo less interaction from surrounding cells 2, and the amplitude of the vibrating membranes 17 increases. Cells 2 having fewer cells 2 constituting second adjacent cells 34 undergo next smaller interaction from surrounding cells 2, and the amplitude of the vibrating membranes 17 increases. The amplitude of the vibrating membranes 17 decreases in order from the cells 2 that are peripheral cells due to having fewer first adjacent cells 33 to the cells 2 that are arranged in the center of the elements 3. That is, the range of peripheral cells 2 constituting the element 3 can be determined based on the number and arrangement of cells 2 constituting the element 3.

There are various methods for improving the durability of the first electrical wiring 13. Initially, a method for improving durability against a scratch will be described.

For example, in FIGS. 1 and 2, the first electrical wiring 13 arranged on the vibrating membranes 17 of the cells 2 arranged on the sides (periphery) of the element 3 among the cells 2 constituting the element 3 has a different width 18. Specifically, the first electrical wiring 13 is configured to have an increased width 18. The increased width 18 of the first electrical wiring 13 makes a crack less likely to occur in part of the first electrical wiring 13. The CMUT 1 can thus be continuously driven without a break. Increasing the width 18 of the first electrical wiring 13 can increase the pull-in voltage of the cells 2 and lower the conversion efficiency of the cells 2. In such a case, the pull-in voltage of the cells 2 constituting the periphery of the element 3 and that of the inner cells 2 can be made equivalent to provide equivalent conversion efficiency by reducing the size of the second electrodes 11 or increasing the distance between the first electrode 7 and the second electrodes 11. The diameter of the second electrodes 11 can be made smaller than that of the gaps 9. If the diameter of the second electrodes 11 is greater than that of the gaps 9, the second electrodes 11 can possibly be formed in areas where there is no gap 9 because of alignment errors during manufacturing. If the second electrodes 11 are formed in areas where there is no gap 9, the first electrode 7 and the second electrodes 11 includes therebetween the second insulation film 8 and the third insulation film 10. This increases parasitic capacitance. The increased parasitic capacitance lowers the signal-to-noise (S/N) ratio of the CMUT 1, resulting in a drop in detection sensitivity. To ensure the provision of the gaps 9 between the first electrode 7 and the second electrodes 11 even in the presence of alignment errors from an exposure apparatus used during manufacturing and patterning errors during manufacturing, the diameter of the second electrodes 11 can be made smaller than that of the gaps 9. The first electrical wiring 12 connects a second electrode 11 to at least one adjoining cell 2. In FIG. 3, the first electrical wiring 12 includes portions overlapping with the gaps 9 and portions not overlapping with the gaps 9. The first electrical wiring 12 ranges over an area 36. The portions of the first electrical wiring 12 overlapping with the gaps 9 constitute the first electrical wiring 13 arranged on the vibrating membranes 17. The first electrical wiring 13 arranged on a vibrating membrane 17 has a length 37, while having the width 18. The length 37 is the difference between the radius of the gaps 9 and that of the second electrodes 11. The length 37 depends on the diameter of the second electrodes 11. As described above, the diameter of the second electrodes 11 can be determined in consideration with the alignment errors of the exposure apparatus and the patterning errors during manufacturing. Suppose, for example, that a stepper apparatus has alignment errors of ±0.05 μm to ±0.1 μm and an aligner apparatus has alignment errors of ±0.5 μm to ±1 μm. In such a case, the diameter of the second electrodes 11 can be 0.1 μm to 2 μm smaller than the diameter of the gaps 9.

It is desirable that the first electrical wiring 13 arranged on the vibrating membranes 17 of the cells 2 arranged on the sides (periphery) of the element 3 be greater in thickness than that of the cells 2 arranged inside. The increased thickness of the first electrical wiring 13 can make a crack less likely to occur in part of the first electrical wiring 13, and the CMUT 1 can be continuously driven without a break. Increasing the thickness of the first electrical wiring 13 can lower the pull-in voltage of the cells 2. If the CMUT 1 is driven by the application of a common bias voltage and a common transmission drive voltage, the cells 2 having a lower pull-in voltage can be pulled, which may cause large variations in the intensity and frequency characteristics of acoustic waves. The pulling-in of the cells 2 also causes build-up of charge on the second insulation films 8, whereby an effective bias voltage applied between the first electrode 7 and the second electrodes 11 is changed. It is desirable that the pull-in voltage of the cells 2 constituting the periphery of the element 3 and that of the inner cells 2 are made equivalent, or desired characteristics might fail to be obtained. If the increased thickness of the first electrical wiring 13 lowers the pull-in voltage of the cells 2, it is desirable that the distance between the first electrode 7 and the second electrodes 11 is increased. In addition to increasing the thickness of the first electrical wiring 13, it is desirable that the thickness of the second electrodes 11 of the cells 2 arranged on the periphery of the element 3 is increased as well. Since the increased thickness of the first electrical wiring 13 can lower the pull-in voltage of the cells 2, the pull-in voltage of the cells 2 constituting the periphery of the element 3 and that of the inner cells 2 are made equivalent as described above, desirably.

Next, durability over long-term driving of the CMUT 1 will be described. If the cells 2 constituting the periphery of the element 3 and the inner cells 2 have the same configuration, the peripheral cells 2 have a greater amplitude due to acoustic interactions. In other words, the first electrical wiring 13 of the cells 2 constituting the periphery undergoes a greater amount of strain. The first electrical wiring 13 of the cells 2 constituting the periphery and that of the cells 2 in the center have the same Young's modulus. According to Hooke's law stating that stress is in proportion to Young's modulus and the amount of strain, the stress acting on the first electrical wiring 13 of the cells 2 constituting the periphery is higher than with the inner cells 2. As the stress acting on the first electrical wiring 13 increases, the wiring strength decreases, and the possibility of a fatigue fracture increases, resulting in a drop in the durability and reliability over long-term driving of the CMUT 1. In view of this, the first electrical wiring 13 of the cells 2 constituting the periphery of the element 3 can be configured to have a different Young's modulus. Specifically, the Young's modulus of the first electrical wiring 13 of the cells 2 constituting the periphery of the element 3 can be reduced to reduce the stress acting on the first electrical wiring 13. The Young's modulus of the second electrodes 11 of the cells 2 constituting the periphery of the element 3 can be reduced as well. The Young's moduli can be reduced by changing the materials of the first electrical wiring 13 and the second electrodes 11. Since the reduced Young's moduli can lower the pull-in voltage, it is desirable that the distance between the first electrode 7 and the second electrodes 11 are increased as described above to make the pull-in voltage of the cells 2 constituting the periphery of the element 3 and that of the inner cells 2 equivalent. Since the reduced Young's moduli can change the frequency characteristics of the vibrating membranes 17 of the cells 2 constituting the periphery, the thicknesses of the members constituting the vibrating membrane 17 and the diameter of the cells 2 can be adjusted to reduce changes in the frequency characteristics.

Another method for reducing the stress is to change the width and/or thickness of the first electrical wiring 13. A more specific method can include reducing the width of the first electrical wiring 13 of the cells 2 constituting the periphery. Since the reduced width of the first electrical wiring 13 can lower the pull-in voltage of the cells 2, the pull-in voltage of the cells 2 constituting the periphery of the element 3 and that of the inner cells 2 can be made equivalent as described above. The thickness of the first electrical wiring 13 in the cells 2 constituting the periphery of the element 3 can also be reduced. Since the reduced thickness of the first electrical wiring 13 can increase the pull-in voltage of the cells 2, the pull-in voltage of the cells 2 constituting the periphery of the element 3 and that of the inner cells 2 can be made equivalent as described above.

In such a manner, even if the amplitude of the vibrating membranes 17 of the cells 2 constituting the periphery of the element 3 increases, the stress acting on the first electrical wiring 13 of the cells 2 constituting the periphery can be reduced and the durability over long-term driving can be prevented from deterioration.

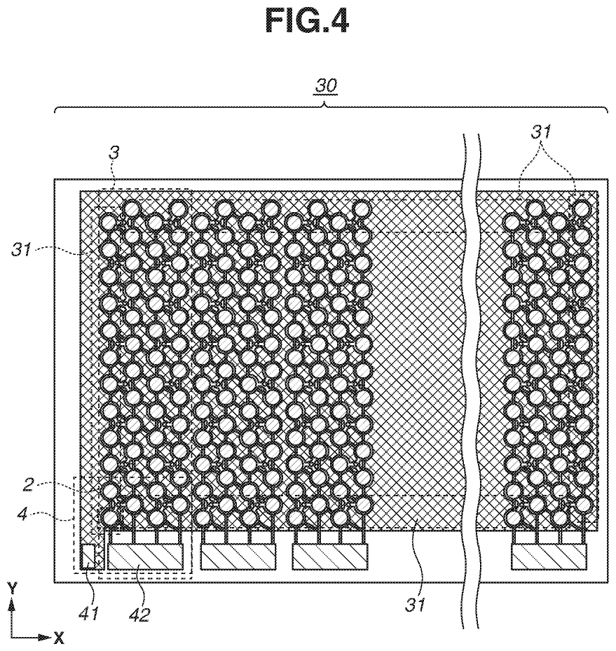

FIG. 4 illustrates another example of the CMUT. FIG. 4 is a top view of a CMUT 30 according to the present exemplary embodiment. In FIG. 4, an area 4 represents the portion enlarged in FIG. 1. In FIG. 4, a single element 3 includes 48 cells 2, whereas any number of cells 2 may be included. While FIG. 4 illustrates four elements 3, the CMUT 30 includes a one-dimensional array of a large number of elements 3 arranged in an X-axis direction. Any number of elements 3 may be included. In FIG. 4, second electrode pads 42 are provided for the respective elements 3. A first electrode 7 is common among all the elements 3. First electrodes 7 may be individually provided for the respective elements 3. In the case of the CMUT 30 illustrated in FIG. 4, the distances between the cells 2 constituting each element 3 and the distances between the elements 3 are the same. The cells 2 constituting the periphery of the elements 3 thus coincide with the peripheral cells 2 constituting the CMUT 30. The cells 2 surrounded by long broken lines 31 indicating peripheral cells are the peripheral cells 2. In the case of the CMUT 30, the durability and reliability of the CMUT 30 can be improved by configuring the first electrical wiring 13 arranged on the vibrating membranes 17 differently between the cells in the portions surrounded by the long broken lines 31 indicating peripheral cells and the other inner cells 2.

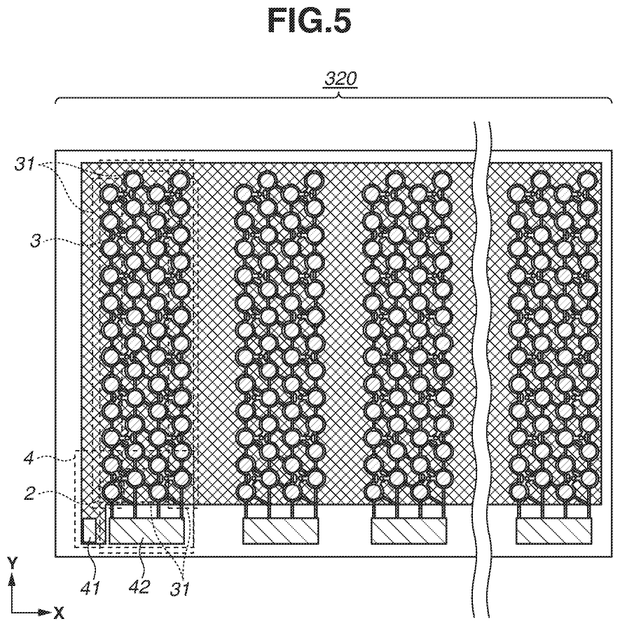

FIG. 5 illustrates yet another example of the CMUT. FIG. 5 is a top view of a CMUT 320 according to the present exemplary embodiment. In FIG. 5, an area 4 represents the portion enlarged in FIG. 1. In the case of the CMUT 320 illustrated in FIG. 5, the distances between the cells 2 constituting each element 3 and the distances between the elements 3 are different. The distances between the elements 3 are greater. In such a case, the cells 2 constituting the periphery of the elements 3 differ in part from the peripheral cells 2 constituting the CMUT 320. The portions surrounded by long broken lines 31 indicating peripheral cells are the peripheral cells 2 of the element 3. In the case of the CMUT 320, the durability and reliability of the CMUT 320 can be improved by configuring the first electrical wiring 13 arranged on the vibrating membranes 17 differently between the cells 2 in the portions surrounded by the long broken lines 31 indicating peripheral cells and the other, inner cells 2. In FIG. 5, some of the long broken lines 31 indicating peripheral cells are omitted. All the elements 3 constituting the CMUT 320 have similar portions to be surrounded by long broken lines 31 indicating peripheral cells. Such a CMUT 320 can be curved in the X-axis direction by making cuts in the portions between the elements 3 for mounting. A convex probe can be constructed by curving the CMUT 320 with the side of the vibrating membranes 17 of the elements 3 convex. In contrast, curving the CMUT 320 with the side of the vibrating membranes 17 of the elements 3 concave can form a focus without beam foaming. The elements 3 can be arranged at distances greater than those between the cells 2 such that cuts can be made.

In FIGS. 1 to 4, the first electrical wiring 13 arranged on the vibrating membranes 17 of the peripheral cells 2 is configured differently from that of the inner cells 2, with the cells 2 surrounded by the long broken lines 31 indicating peripheral cells as the peripheral cells 2. However, the cells 2 lying immediately inside the long broken lines 31 indicating peripheral cells may be regarded as peripheral cells 2, and the first electrical wiring 13 arranged on the vibrating membranes 17 of such peripheral cells 2 may be configured differently from that of the inner cells 2. The configuration of the first electrical wiring 13 arranged on the vibrating membranes 17 may be gradually changed from the cells 2 located near the center of gravity of the outer shape of the element 3 to outside.

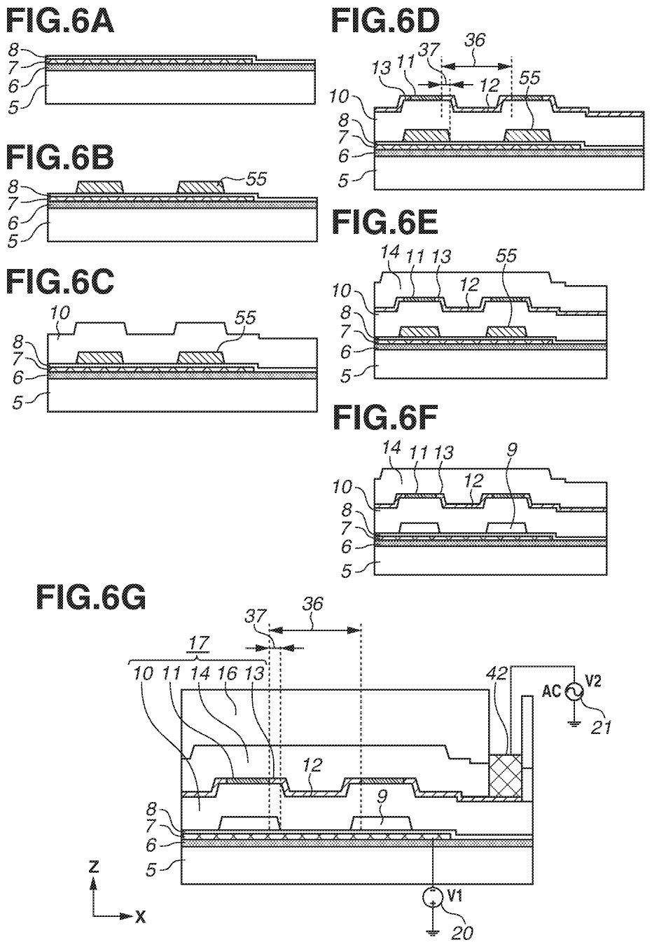

Next, an example of a method for manufacturing the CMUT 1 according to the present exemplary embodiment will be described with reference to FIGS. 6A to 6G.

FIGS. 6A to 6G are sectional views taken along the line A-B of FIG. 1. As illustrated in FIG. 6A, a first insulation film 6 is formed on a substrate 5. The substrate 5 is a silicon substrate. The first insulation film 6 is intended to provide insulation from a first electrode 7. If the substrate 5 is an insulating substrate such as a glass substrate, the first insulation film 6 may not to be formed. The substrate 5 is desirably one having low surface roughness. If the surface roughness is high, the surface roughness is transferred even through deposition steps after the present step, and the distance between the first electrode 7 and the second electrodes 11, which depends on the surface roughness, varies from one cell to another. Such variations lead to variations in the conversion efficiency, which in turn lead to sensitivity and band variations. The substrate 5 is therefore desirably one having low surface roughness. The first electrode 7 is then formed. The first electrode 7 is desirably made of a conductive material having low surface roughness. Examples include titanium, tungsten, and aluminum. As with the substrate 5, if the first electrode 7 has high surface roughness, the distance between the first electrode 7 and the second electrodes 11, which depends on the surface roughness, varies from one cell to another and from one element to another. Conductive materials having low surface roughness are therefore desirable. Since the surface roughness increases with the thickness of the first electrode 7, it is desirable that the thickness of the first electrode 7 is small. Next, a second insulation film 8 is formed as illustrated in FIG. 6A. The second insulation film 8 is desirably made of an insulating material having low surface roughness. The second insulation film 8 is formed for the purpose of preventing an electrical short circuit or dielectric breakdown between the first electrode 7 and the second electrodes 11 when a voltage is applied across the first electrode 7 and the second electrodes 11. The second insulation film 8 is also formed for the purpose of preventing the first electrode 7 from being etched during removal of a sacrifice layer in a step after the present step. As with the substrate 5, if the second insulation film 8 has high surface roughness, the distance between the first electrode 7 and the second electrodes 11, which depends on the surface roughness, varies from one cell to another. The second insulation film 8 therefore desirably has low surface roughness. Examples include a silicon nitride film and a silicon oxide film. Since the surface roughness increases with the thickness, the second insulation film 8 has a minimum thickness needed to maintain insulation.

Next, as illustrated in FIG. 6B, a sacrifice layer 55 is formed. The sacrifice layer 55 is desirably made of a material having low surface roughness. As with the substrate 5, if the sacrifice layer 55 has high surface roughness, the distance between the first electrode 7 and the second electrodes 11, which depends on the surface roughness, varies from one cell to another. The sacrifice layer 55 therefore desirably has low surface roughness. To reduce the etching time to remove the sacrifice layer 55, materials having a high etching rate are desirable. The sacrifice layer 55 is desirably made of a material such that the second insulation film 8 and the third insulation film 10 constituting the vibrating membranes 17 are hardly etched by the etchant or etching gas for removing the sacrifice layer 55. If the second insulation film 8 and the third insulation film 10 constituting the vibrating membranes 17 can be etched by the etchant or etching gas for removing the sacrifice layer 55, the vibrating membranes 17 varies in thickness, and the distance between the first electrode 7 and the second electrodes 11 varies. Variations in the thickness of the vibrating membranes 17 and the distance between the first electrode 7 and the second electrodes 11 lead to sensitivity and band variations between the cells 2. If the second insulation film 8 and the vibrating membranes 17 are silicon nitride films or silicon oxide films, the sacrifice layer 55 is desirably made of a material that has low surface roughness and such that an etchant or etching gas less likely to etch the second insulation film 8 and the vibrating membranes 17 can be used. Examples include amorphous silicon, polyimide, and chromium. In particular, if the second insulation film 8 and the vibrating membranes 17 are silicon nitride films or silicon oxide films, chromium is desirable since silicon nitride films and silicon oxide films are hardly etched by chromium etchants.

Next, as illustrated in FIG. 6C, a third insulation film 10 is formed. The third insulation film 10 desirably has low tensile stress. For example, a tensile stress of 500 MPa or less is desirable. Silicon nitride films are capable of stress control and can be formed to have a low tensile stress of 500 MPa or less. If the vibrating membranes 17 have compressive stress, the vibrating membranes 17 may undergo sticking or buckling and deform largely. With high tensile stress, the third insulation film 10 can be broken. The third insulation film 10 therefore desirably has low tensile stress. An example is a silicon nitride film that is capable of stress control and can be formed to have low tensile stress. Since the third insulation film 10 is deposited over the sacrifice layer 55, the third insulation film 10 can have a thickness that ensures coverage of the sacrifice layer.

Next, as illustrated in FIG. 6D, second electrodes 11 are formed. First electrical wiring 12 for connecting the second electrodes 11 of adjoining cells 2 is also formed. First electrical wiring 13 arranged on the third insulation film 10 that makes the vibrating membranes 17 afterward is also formed. The length 37 of the first electrical wiring 13 arranged on a vibrating membrane 17 refers to the length of the portion indicated by the dot lines, between the outer profile of a sacrifice layer 55 and the outer profile of the corresponding second electrode 11. The second electrodes 11, the first electrical wiring 12, and the first electrical wiring 13 arranged on the vibrating membranes 17 can be formed by changing the order and the numbers of times of deposition, patterning, and etching based on the width and thickness of the first electrical wiring 13 arranged on the vibrating membranes 17 and depending on different materials. The second electrodes 11, the first electrical wiring 12, and the first electrical wiring 13 arranged on the vibrating membranes 17 are desirably made of materials having low residual stress. Examples include aluminum, titanium, gold, aluminum alloys, titanium alloys, and gold alloys. If a sacrifice layer removal step or a sealing step is performed after the formation of the second electrodes 11, the first electrical wiring 12, and the first electrical wiring 13 arranged on the vibrating membranes 17, the second electrodes 11 are desirably made of a material having etching resistance against the etching of the sacrifice layer 55 as well as heat resistance. Examples include aluminum silicon alloys and titanium. The second electrodes 11, the first electrical wiring 12, and the first electrical wiring 13 arranged on the vibrating membranes 17 can be formed in a thickness that ensures step coverage at the surface.

Next, as illustrated in FIG. 6E, a fourth insulation film 14 is formed. The fourth insulation film 14 desirably has low tensile stress. For example, a tensile stress of 500 MPa or less is desirable. Silicon nitride films are capable of stress control and can be formed to have a low tensile stress of 500 MPa or less. If the vibrating membranes 17 have compressive stress, the vibrating membranes 17 undergo sticking or buckling and deform largely. With high tensile stress, the fourth insulation film 14 can be broken. The fourth insulation film 14 therefore desirably has low tensile stress. An example is a silicon nitride film, which is capable of stress control and can be formed to have low tensile stress. The provision of the fourth insulation film 14 can control sagging of the third insulation film 10, the second electrodes 11, and the first electrical wiring 13 arranged on the vibrating membranes 17 after the etching of the sacrifice layer 55.

Next, as illustrated in FIG. 1, etching holes 15 are formed in the third insulation film 10 and the fourth insulation film 14. The etching holes 15 are intended to let in the etchant or etching gas for removing the sacrifice layer 55 by etching.

Next, as illustrated in FIG. 6F, the sacrifice layer 55 is removed to form gaps 9. The sacrifice layer 55 can be removed by a method such as wet etching and dry etching, desirably. If chromium is used as the material of the sacrifice layer 55, wet etching is desirable. If amorphous silicon is used as the material of the sacrifice layer 55, dry etching is desirable.

Next, as illustrated in FIG. 6G, a sealing film 16 is formed to seal the etching holes 15. The third insulation film 10, the second electrodes 11, the first electrical wiring 13 arranged on the vibrating membranes 17, the fourth insulation film 14, and the sealing film 16 constitute the vibrating membranes 17. The etching holes 15 are sealed by the sealing film 16. The sealing film 16 needs to be formed such that no liquid or ambient air enters the gaps 9. If the gaps 9 are at the atmospheric pressure, the gas in the gaps 9 expands and contracts with temperature changes. Since the gaps 9 are subjected to a high electric field, the reliability of the element 3 can also drop due to electrolytic dissociation of molecules. The sealing therefore needs to be performed in a decompressed environment. Decompressing the interior of the gaps 9 can reduce air resistance in the gaps 9. This facilitates the vibration of the vibrating membranes 17, thus increasing sensitivity of the CMUT 1. The sealing also enables the CMUT 1 to be used in a liquid. For high adhesiveness, the same material as that of the fourth insulation film 14 is desirably used as the sealing material. The sealing film 16 is desirably formed in a thickness that ensures step coverage at the surface. If the fourth insulation film 14 is made of silicon nitride, the sealing film 16 can also be made of silicon nitride. After the formation of the sealing film 16, a second electrode pad 42 is formed. Through the second electrode pad 42, an electrical signal can be taken out from the second electrodes 11 and a voltage can be applied to the second electrodes 11.

FIGS. 6A to 6G illustrate a configuration in which the second electrodes 11 are sandwiched between the third insulation film 10 and the fourth insulation film 14 as an example. Alternatively, after the formation of the third insulation film 10, the etching holes 15 may be formed to perform the etching the sacrifice layer 55 without the formation of the fourth insulation film 14. The sealing film 16 then may be formed before the provision of the second electrodes 11. Here, since the second electrodes 11 exposed at the outermost surface increase the possibilities of short circuit of the element 3 by foreign substances, the second electrodes 11 are desirably formed between the insulation films 10 and 14.

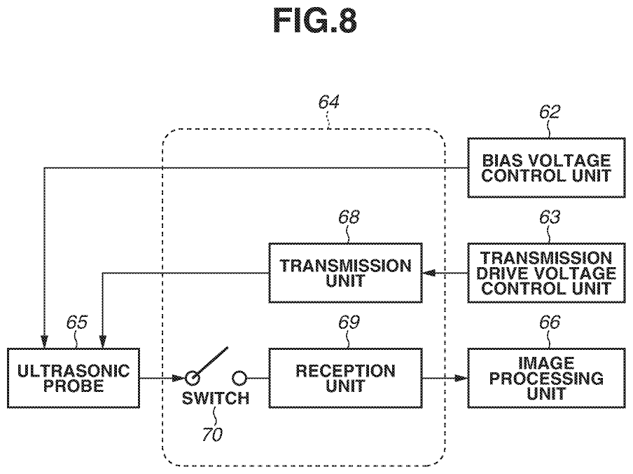

Through the foregoing steps, the CMUT 1 of FIG. 2 can be fabricated as illustrated in FIG. 6G. Voltages can be applied to the first electrode 7 and the second electrodes 11 by using not-illustrated lead wiring electrically connected to the first electrode pad 41 and the second electrode pad 42 in FIG. 2. If the CMUT 1 is used to receive ultrasonic waves, a direct-current voltage is applied to the first electrode 7. Receiving ultrasonic waves, the vibrating membranes 17 including the second electrodes 11 deform and thus the distances of the gaps 9 between the second electrodes 11 and the first electrode 7 change, resulting in change in capacitance. The change in capacitance produce a current to flow through the lead wiring. A transmission and reception circuit 64 illustrated in FIG. 8 performs current-to-voltage conversion on the current, whereby the ultrasonic waves can be received as a voltage. If a direct-current voltage is applied to the first electrode 7 and a transmission drive voltage is applied to the second electrodes 11, the vibrating membranes 17 can be vibrated by electrostatic force. Ultrasonic waves can thereby be transmitted.

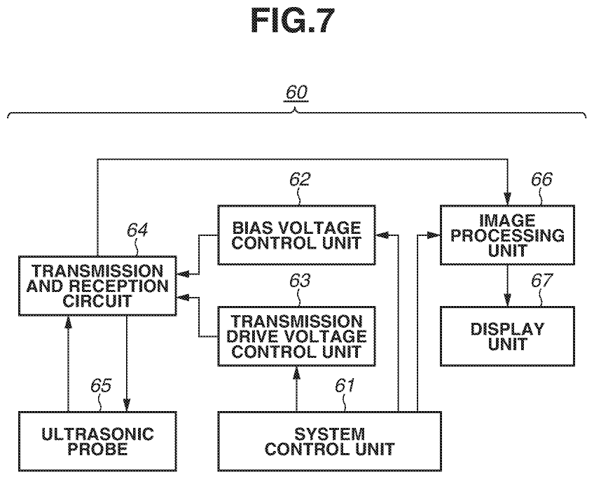

FIG. 7 illustrates an example of a driving apparatus. A driving apparatus 60 includes a system control unit 61, a bias voltage control unit 62, a transmission drive voltage control unit 63, the transmission and reception circuit 64, an ultrasonic probe 65, an image processing unit 66, and a display unit 67. The ultrasonic probe 65 includes a CMUT 1 for transmitting ultrasonic waves to a subject and receiving ultrasonic waves reflected from the subject. The transmission and reception circuit 64 supplies a bias voltage and a transmission drive voltage supplied from outside to the ultrasonic probe 65, and processes the ultrasonic waves received by the ultrasonic probe 65 and outputs the resulting signal to the image processing unit 66. The bias voltage control unit 62 supplies the bias voltage to the transmission and reception circuit 64 for the purpose of supplying the bias voltage to the ultrasonic probe 65. The bias voltage control unit 62 includes a not-illustrated power supply and switch. The bias voltage control unit 62 supplies the bias voltage to the transmission and reception circuit 64 at timing instructed by the system control unit 61. The transmission drive voltage control unit 63 supplies the transmission drive voltage to the transmission and reception circuit 64 for the purpose of supplying the transmission drive voltage to the ultrasonic probe 65. The transmission drive voltage control unit 63 supplies a waveform that provides desired frequency characteristics and transmission sound pressure level to the transmission and reception circuit 64 at timing instructed by the system control unit 61. The image processing unit 66 performs image conversion (such as conversion into a brightness (B) mode image or a motion (M) mode image) by using the signal output from the transmission and reception circuit 64, and outputs the resulting image signal to the display unit 67. The display unit 67 is a display device that displays the image signal output from the image processing unit 66. The display unit 67 may be configured as a member separate from the driving apparatus 60. The system control unit 61 is a circuit for controlling the bias voltage control unit 62, the transmission drive voltage control unit 63, and the image processing unit 66.

FIG. 8 illustrates an example of the transmission and reception circuit 64. The transmission and reception circuit 64 includes a transmission unit 68, a reception unit 69, and a switch 70. During transmission driving, the transmission and reception circuit 64 applies a bias voltage applied from the bias voltage control unit 62 to the ultrasonic probe 65 based on a transmission bias voltage instructed by the system control unit 61 of FIG. 7. Similarly, the transmission and reception circuit 64 applies the voltage (transmission drive voltage) applied from the transmission drive voltage control unit 63 to the ultrasonic probe 65 via the transmission unit 68 based on a transmission voltage instructed by the system control unit 61. If the transmission drive voltage is applied, the switch 70 is opened so that no signal flows through the reception unit 69. If the transmission drive voltage is not applied, the switch 70 is closed, bringing the transmission and reception circuit 64 into a reception state. The switch 70 includes a not-illustrated diode, and serves as a protection circuit for preventing breakdown of the reception unit 69. If the ultrasonic probe 65 transmits ultrasonic waves and the ultrasonic waves reflected from the subject return to the ultrasonic probe 65, the ultrasonic probe 65 receives the ultrasonic waves. During reception, the transmission and reception circuit 64 applies a bias voltage applied from the bias voltage control unit 62 to the ultrasonic probe 65 based on a reception bias voltage instructed by the system control unit 61 of FIG. 7. Since the switch 70 is closed, the reception signal is amplified by the reception unit 69 and delivered to the image processing unit 66.

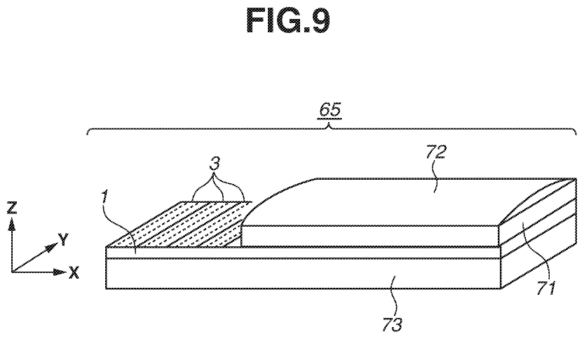

FIG. 9 illustrates a perspective view of an example of the ultrasonic probe 65. The ultrasonic probe 65 includes the CMUT 1 (capacitive ultrasonic transducer), an acoustic matching layer 71, an acoustic lens 72, and a circuit substrate 73. As illustrated in FIG. 9, the CMUT 1 includes a large number of elements 3 arranged in the X direction as a one-dimensional array. While the elements 3 in FIG. 9 are arranged in a one-dimensional array, the elements 3 may be arranged in a two-dimensional array. The elements 3 may be arranged in other configurations, such as a convex configuration. The CMUT 1 is mounted on and electrically connected to the circuit substrate 73. The circuit substrate 73 may be one integrated with the transmission and reception circuit 64 illustrated in FIG. 8. The CMUT 1 may be electrically connected to the transmission and reception circuit 64 illustrated in FIG. 8 via the circuit substrate 73. For the sake of acoustic impedance matching with the subject, the acoustic matching layer 71 is provided on the surface side of the CMUT 1 from which ultrasonic waves are transmitted. The acoustic matching layer 71 may be provided as a protection film for preventing leakage of electricity to the subject. The acoustic lens 72 is arranged via the acoustic matching layer 71. The acoustic lens 72 that can provide acoustic impedance matching between the subject and the acoustic matching layer 71 can be used. The provision of the acoustic lens 72 having a curvature in the Y direction as illustrated in FIG. 9 enables focusing of ultrasonic waves spreading out in the Y direction upon a focus position of the acoustic lens 72. With such a configuration alone, ultrasonic waves spreading out in the X direction are unable to be focused. The elements 3 are then driven to transmit ultrasonic waves at different timings in a beamforming manner, whereby the ultrasonic waves can be focused on the focus position. It is desirable that the acoustic lens 72 is formed in a shape that provides desired ultrasonic distribution characteristics. The types and shapes of the acoustic matching layer 71 and the acoustic lens 72 can be selected based on the type of target subject. The acoustic matching layer 71 and the acoustic lens 72 may even be omitted. The bias voltage and the transmission drive voltage are supplied to the ultrasonic probe 65, and the reception signal resulting from the reception of the ultrasonic waves reflected from the subject is transmitted to the transmission and reception circuit 64 or the image processing unit 66, via a not-illustrated cable.

A first exemplary embodiment will be described below. To explain the disclosure, the present exemplary embodiment describes a structure of a CMUT 1 and a method for manufacturing the same. The CMUT 1 according to the present exemplary embodiment will be described with reference to FIGS. 1, 2, 6A to 6G, 10, and 11. In the present exemplary embodiment, a width 18 of first electrical wiring 13 arranged on vibrating membranes 17 will be described.

The CMUT 1 illustrated in FIG. 2 has outer dimensions of 500 μm in the Y direction and 500 μm in the X direction. An entire element 3 has outer dimensions of 470 μm in the X direction and 470 μm in the Y direction. FIG. 6G is a sectional view taken along the line A-B of FIG. 1. Cells 2 constituting the element 3 have a substantially circular shape except where connected to etching holes 15. Gaps 9 have a diameter of 36 μm. The diameter of a gap 9 refers to that of the gap 9 on the side of a second insulation film 8 where the second insulation film 8 and a third insulation film 10 are in contact with each other. As illustrated in FIG. 1, the cells 2 are arranged in a close-packed configuration. The cells 2 constituting an element 3 are each arranged at distances of 39 μm from adjoining cells 2. In other words, the shortest distance between the gaps 9 of adjoining cells 2 is 3 μm.

A sectional structure and a manufacturing method will be described with reference to FIGS. 6A to 6G. As illustrated in FIG. 6G, each cell 2 includes a 300-μm-thick silicon substrate 5, a first insulation film 6 formed on the silicon substrate 5, a first electrode 7 formed on the first insulation film 6, and the second insulation film 8 on the first electrode 7. The cell 2 further includes a vibrating membrane 17 including a second electrode 11, the first electrical wiring 13 arranged on the vibrating membrane 17, the third insulation film 10, a fourth insulation film 14, and a sealing film 16, and a gap 9. The cell 2 further includes first electrical wiring 12 that connects adjoining second electrodes 11. The gap 9 has a height of 140 nm. The height of the gap 9 refers to the distance in a Z-axis direction. The CMUT 1 further includes a first voltage application unit 20 that applies a bias voltage across the first electrode 7 and the second electrodes 11, and a second voltage application unit 21 that applies a transmission drive voltage to the second electrodes 11.

The first insulation film 6 is a 1-μm-thick silicon oxide film formed by thermal oxidation. The second insulation film 8 is a 100-nm-thick silicon oxide film formed by plasma enhanced chemical vapor deposition (PE-CVD). The first electrode 7 is made of tungsten with a thickness of 100 nm. The second electrodes 11, the first electrical wiring 12, and the first electrical wiring 13 arranged on the vibrating membranes 17 are made of an Al—Nd alloy with a thickness of 100 nm. The second electrodes 11 have a diameter of 32 μm. The first electrical wiring 12 has a width of 5 μm. The width 18 of the first electrical wiring 13 arranged on the vibrating membranes 17 can be changed as appropriate. In the present exemplary embodiment, the width 18 is changed to 2 μm, 5 μm, 10 μm, 20 μm, and 30 μm CMUT by CMUT. A length 37 of the first electrical wiring 13 arranged on the vibrating membranes 17 is 2 μm. The third insulation film 10, the fourth insulation film 14, and the sealing film 16 are silicon nitride films formed by PE-CVD. The third insulation film 10, the fourth insulation film 14, and the sealing film 16 are formed to have a tensile stress of 450 MPa or less. The third insulation film 10 has a thickness of 350 nm, the fourth insulation film 14 a thickness of 400 nm, and the sealing film 16 a thickness of 450 nm. The second electrode pad 42 is made of Al with a thickness of 500 nm. A sacrifice layer 55 according to the present exemplary embodiment is made of amorphous silicon. The sacrifice layer 55 is removed by xenon fluoride-based dry etching.

CMUTs 1 such as illustrated in FIG. 2 can be formed with the method described above. The first electrical wiring 12 has a width of 5 μm. That is, the width 18 of the first electrical wiring 13 arranged on the vibrating membranes 17 of the inner cells 2 constituting the element 3 is also 5 μm. The CMUTs 1 in which the width 18 of the first electrical wiring 13 arranged on the vibrating membranes 17 of the cells 2 constituting the periphery of the element 3 is changed to 10 μm, 20 μm, and 30 μm have improved durability against a scratch since the width 18 is wider than that of the inner cells 2 of the element 3. The durability and reliability of the CMUTs 1 can thereby be improved.

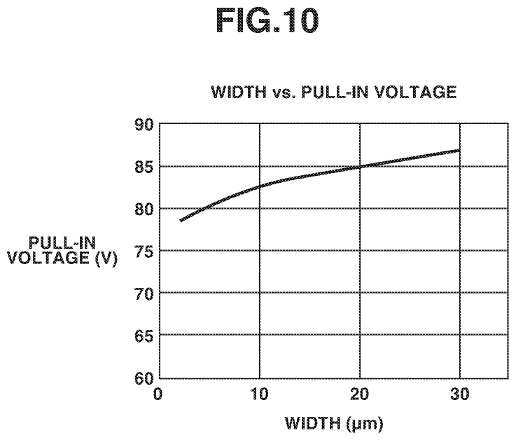

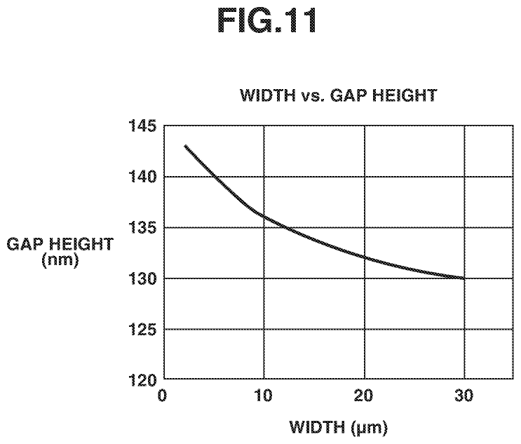

FIG. 10 illustrates a relationship between the width 18 of the first electrical wiring 13 arranged on the vibrating membranes 17 of the cells 2 constituting the periphery of the element 3 and the pull-in voltage. The horizontal axis indicates the width 18 of the first electrical wiring 13, and the vertical axis the pull-in voltage of the cells 2 with such a width. As illustrated in FIG. 10, the pull-in voltage increases as the width 18 of the first electrical wiring 13 arranged on the vibrating membranes 17 increases. The width 18 of the first electrical wiring 13 arranged on the vibrating membranes 17 of the inner cells 2 of the element 3 is 5 μm, and the pull-in voltage of the inner cells 2 is 81 V. If, for example, the width 18 of the first electrical wiring 13 arranged on the vibrating membranes 17 of the peripheral cells 2 of the element 3 is 30 μm, the pull-in voltage of the peripheral cells 2 is 87 V. There is a difference of 6 V between the pull-in voltages within the same element 3. Since such a difference in pull-in voltage causes sensitivity variations, the pull-in voltages of the cells 2 constituting the element 3 are desirably made equivalent by adjusting the distance between the first electrode 7 and the second electrodes 11 as appropriate. FIG. 11 illustrates a relationship between the height of the gaps 9 and the width 18 of the first electrical wiring 13 arranged on the vibrating membranes 17 where the pull-in voltage is 81 V. The horizontal axis indicates the width 18 of the first electrical wiring 13, and the vertical axis the height of the gaps 9. As illustrated in FIG. 11, the pull-in voltages of the cells 2 constituting the element 3 can be made equivalent by adjusting the height of the gaps 9. If the width 18 of the first electrical wiring 13 arranged on the vibrating membranes 17 of the peripheral cells 2 of the element 3 is 30 μm, the height of the gaps 9 is adjusted to 130 nm. If the width 18 is 20 μm, the height of the gaps 9 is adjusted to 132 nm. If the width 18 is 10 μm, the height of the gaps 9 is adjusted to 136 nm. In such a manner, the durability of the peripheral cells 2 of the element 3 against a scratch can be improved and sensitivity variations of the cells 2 constituting the element 3 can be reduced as well by making the pull-in voltages of the cells 2 constituting the element 3 equivalent. In the present exemplary embodiment, the distance between the first electrode 7 and the second electrodes 11 is adjusted by the height of the gaps 9. However, the thickness of the second insulation film 8 and/or the third insulation film 10 may be adjusted to adjust the pull-in voltages of the cells 2 constituting the element 3.

A second exemplary embodiment will be described below. To explain the disclosure, the present exemplary embodiment describes a structure of a CMUT 1 and a method for manufacturing the same. The CMUT 1 according to the present exemplary embodiment will be described with reference to FIGS. 6A to 6G, 11, 12, 13, 14, and 15. In the present exemplary embodiment, the thickness of first electrical wiring 13 arranged on vibrating membranes 17 will be described.

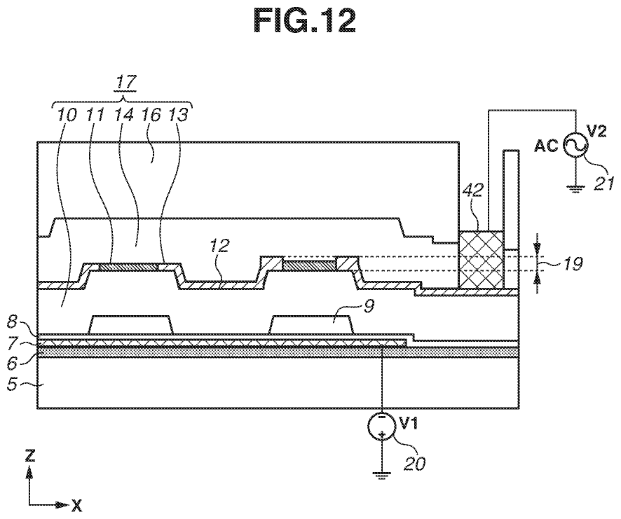

The structure and manufacturing method of the CMUT 1 according to the present exemplary embodiment are basically the same as those of the first exemplary embodiment. Differences from the first exemplary embodiment lie in the thickness of the first electrical wiring 13 arranged on the vibrating membranes 17 of the peripheral cells 2 of the element 3 and the width 18 of the first electrical wiring 13 arranged on the vibrating membranes 17. In the present exemplary embodiment, both the width 18 of the first electrical wiring 13 arranged on the vibrating membranes 17 of the peripheral cells 2 of the element 3 and that of the first electrical wiring 13 arranged on the vibrating membranes 17 of the inner cells 2 of the element 3 are 5 μm. The width of the first electrical wiring 12 is 5 μm. The thickness of the first electrical wiring 13 arranged on the vibrating membranes 17 of the peripheral cells 2 of the element 3 is changed to 50 nm, 100 nm, 140 nm, 200 nm, and 300 nm CMUT by CMUT. The thickness of the first electrical wiring 13 arranged on the vibrating membranes 17 of the inner cells 2 of the element 3 is 140 nm. CMUTs 1 such as illustrated in FIG. 2 can be formed with a similar method to that of the first exemplary embodiment. FIG. 12 illustrates an example of a sectional structure according to the present exemplary embodiment.

CMUTs 1 in which the first electrical wiring 13 arranged on the vibrating membranes 17 of the cells 2 constituting the periphery of the element 3 has a thickness 19 greater than 140 nm have improved durability against a scratch since the thickness 19 is greater than that of the inner cells 2 of the element 3. The durability and reliability of the CMUTs 1 can thereby be improved.

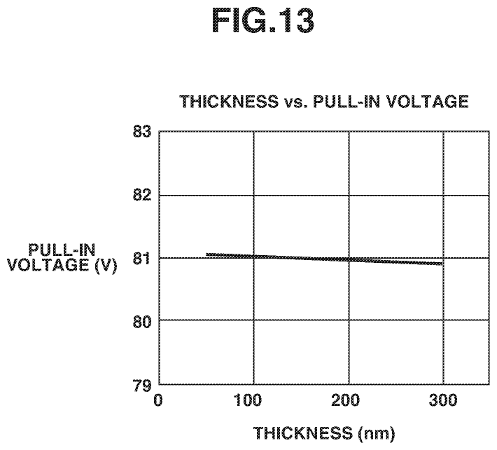

FIG. 13 illustrates a relationship between the thickness 19 of the first electrical wiring 13 arranged on the vibrating membranes 17 of the cells 2 constituting the periphery of the element 3 and the pull-in voltage. The horizontal axis indicates the thickness 19 of the first electrical wiring 13, and the vertical axis the pull-in voltage of the cells 2 with such a thickness. As illustrated in FIG. 13, the pull-in voltage changes little even if the thickness 19 of the first electrical wiring 13 arranged on the vibrating membranes 17 increases. If the thickness 19 of the first electrical wiring 13 is 140 nm, the pull-in voltage is 81 V. For 300 nm, the pull-in voltage is 80.9 V. The difference is 0.1 V, which is less than or equal to the detection limit of a normal pull-in voltage. By increasing the thickness 19 of the first electrical wiring 13 arranged on the vibrating membranes 17 of the cells 2 constituting the periphery of the element 3, the durability against a scratch can thus be improved without variations in pull-in voltage between the inner and peripheral cells 2 of the element 3.

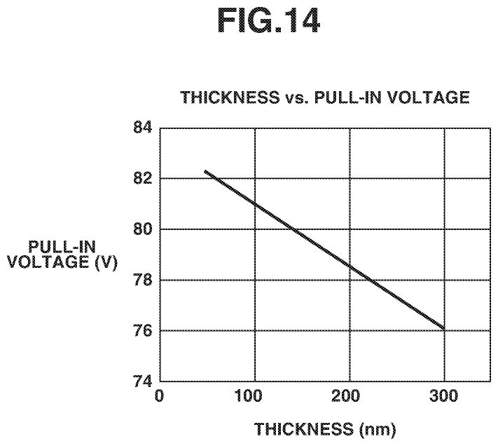

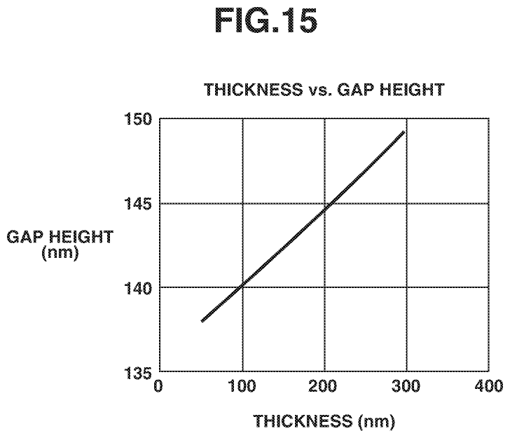

Description will be provided of a case where the thickness of the second electrodes 11 is changed to 50 nm, 100 nm, 140 nm, 200 nm, and 300 nm CMUT by CMUT along with the thickness 19 of the first electrical wiring 13 arranged on the vibrating membranes 17 of the peripheral cells 2 of the element 3. The CMUTs 1 with different thicknesses of the second electrodes 11 and different thicknesses 19 of the first electrical wiring 13 can be manufactured through the foregoing method. As for a sectional structure, the thickness of the second electrode 11 illustrated in the center of FIG. 12 is changed to the same thickness as the thickness 19 of the first electrical wiring 13. FIG. 14 illustrates a relationship of the thickness of the second electrodes 11 of the cells 2 constituting the periphery of the element 3 and the thickness 19 of the first electrical wiring 13 arranged on the vibrating membranes 17 to the pull-in voltage. The horizontal axis indicates the thickness of the second electrodes 11 of the cells 2 and the thickness 19 of the first electrical wiring 13, and the vertical axis the pull-in voltage of the cells 2 with such thicknesses. As illustrated in FIG. 14, the pull-in voltage decreases as the thickness of the second electrodes 11 and the thickness 19 of the first electrical wiring 13 arranged on the vibrating membranes 17 increase. The thickness of the second electrodes 11 of the inner cells 2 of the element 3 and the thickness 19 of the first electrical wiring 13 are 140 nm, and the pull-in voltage of the cells 2 with such thicknesses is 81 V. If, for example, the thickness of the second electrodes 11 of the peripheral cells 2 of the element 3 and the thickness 19 of the first electrical wiring 13 are 300 nm, the pull-in voltage of the cells 2 with such thicknesses is 77 V. There is a difference of 4 V between the pull-in voltages within the same element 3. Since such a difference causes sensitivity variations, the pull-in voltages of the cells 2 constituting the element 3 are desirably made equivalent by adjusting the distance between the first electrode 7 and the second electrodes 11 as appropriate. FIG. 15 illustrates a relationship of the height of the gaps 9 to the thickness of the second electrodes 11 and the thickness 19 of the first electrical wiring 13 arranged on the vibrating membranes 17 where the pull-in voltage is 81 V. The horizontal axis indicates the thickness of the second electrodes 11 and the thickness 19 of the first electrical wiring 13 arranged on the vibrating membranes 17, and the vertical axis the height of the gaps 9. As illustrated in FIG. 15, the pull-in voltages of the cells 2 constituting the element 3 can be made equivalent by adjusting the height of the gaps 9. If the thickness of the second electrodes 11 and the thickness 19 of the first electrical wiring 13 arranged on the vibrating membranes 17 is 300 nm, a pull-in voltage of 81 V can be obtained by adjusting the height of the gaps 9 to 149 nm.

As described above, the durability of the peripheral cells 2 of the element 3 against a scratch can be improved and sensitivity variations of the cells 2 constituting the element 3 can be reduced as well by making the pull-in voltages of the cells 2 constituting the element 3 equivalent. In the present exemplary embodiment, the distance between the first electrode 7 and the second electrodes 11 is adjusted by the height of the gaps 9. However, the thickness of the second insulation film 8 and/or the third insulation film 10 may be adjusted to adjust the pull-in voltages of the cells 2 constituting the element 3.

A third exemplary embodiment will be described below. To explain the disclosure, the present exemplary embodiment describes a structure of a CMUT 1 and a method for manufacturing the same. The CMUT 1 according to the present exemplary embodiment will be described with reference to FIGS. 6A to 6G, 16, and 17. In the present exemplary embodiment, the Young's modulus of first electrical wiring 13 arranged on vibrating membranes 17 will be described.

The structure and manufacturing method of the CMUT 1 according to the present exemplary embodiment are basically the same as those of the first exemplary embodiment. Differences from the first exemplary embodiment lie in that the width of the first electrical wiring 13 arranged on the vibrating membranes 17 in both the inner and peripheral cells 2 of the element 3 is the same, 5 μm, and that the Young's modulus of the first electrical wiring 13 arranged on the vibrating membranes 17 is different between the inner and peripheral cells 2 of the element 3. In the present exemplary embodiment, the Young's modulus of the first electrical wiring 13 arranged on the vibrating membranes 17 of the peripheral cells 2 of the element 3 is changed within the range of 10 GPa to 150 GPa CMUT by CMUT. The first electrical wiring 13 arranged on the vibrating membranes 17 of the inner cells 2 of the element 3 has a Young's modulus of 70.3 GPa and is made of Al—Nd. CMUTs 1 such as illustrated in FIG. 2 can be formed by a similar method to that of the first exemplary embodiment.

The first electrical wiring 13 arranged on the vibrating membranes 17 of the inner cells 2 of the element 3 has a Young's modulus of 70.3 GPa. If the first electrical wiring 13 arranged on the vibrating membranes 17 of the cells 2 constituting the periphery of the element 3 has a Young's modulus of less than 70.3 GPa, the durability of such cells 2 over long-term driving can be improved. For example, if the first electrical wiring 13 arranged on the vibrating membranes 17 of the cells 2 constituting the periphery of the element 3 is made of Al having a Young's modulus of 68 GPa, the durability and reliability of the CMUT 1 can be improved. A case where the first electrical wiring 13 arranged on the vibrating membranes 17 of the inner cells 2 of the element 3 is made of Ti having a Young's modulus of 100 GPa will be described. In such a case, the durability of the cells 2 constituting the periphery of the element 3 over long-term driving can be improved by forming the first electrical wiring 13 arranged on the vibrating membranes 17 of the cells 2 constituting the periphery of the element 3 out of Al—Nd having a Young's modulus of 70.3 GPa. In such a manner, the durability and reliability of the CMUT 1 can be improved.

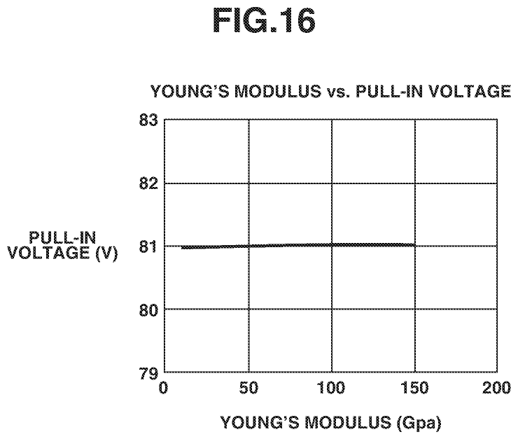

FIG. 16 illustrates a relationship between the Young's modulus of the first electrical wiring 13 arranged on the vibrating membranes 17 of the cells 2 constituting the periphery of the element 3 and the pull-in voltage. The horizontal axis indicates the Young's modulus of the first electrical wiring 13, and the vertical axis is the pull-in voltage of the cells 2 with such a Young's modulus. As illustrated in FIG. 16, the pull-in voltage changes little even if the Young's modulus of the first electrical wiring 13 arranged on the vibrating membranes 17 changes. If the first electrical wiring 13 has a Young's modulus of 10 GPa, the pull-in voltage is 80.9 V. For a Young's modulus of 150 GPa, the pull-in voltage is 81 V. The difference is 0.1 V, which can be said to be less than or equal to the detection limit of a normal pull-in voltage. By reducing the Young's modulus of the first electrical wiring 13 arranged on the vibrating membranes 17 of the cells 2 constituting the periphery of the element 3, the durability over long-term driving can thus be improved without variations in pull-in voltage between the inner and peripheral cells 2 of the element 3.

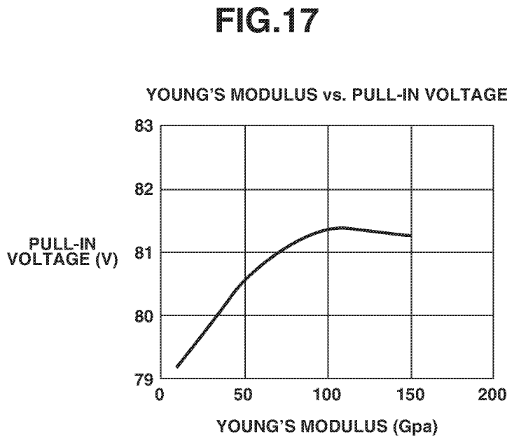

Now, description will be provided of a case where the Young's modulus of the second electrodes 11 is changed in the range of 10 GPa to 150 GPa CMUT by CMUT along with that of the first electrical wiring 13 arranged on the vibrating membranes 17 of the peripheral cells 2 of the element 3. The CMUTs with different Young's moduli of the second electrodes 11 and different Young's moduli of the first electrical wiring 13 can be manufactured by using the method described above. FIG. 17 illustrates a relationship of the Young's modulus of the second electrodes 11 of the cells 2 constituting the periphery of the element 3 and the Young's modulus of the first electrical wiring 13 arranged on the vibrating membranes 17 to the pull-in voltage. The horizontal axis indicates the Young's modulus of the second electrodes 11 of the cells 2 and the Young's modulus of the first electrical wiring 13, and the vertical axis the pull-in voltage of the cells 2 with such Young's moduli. As illustrated in FIG. 17, the pull-in voltage increases as the Young's moduli of the second electrodes 11 and the first electrical wiring 13 arranged on the vibrating membranes 17 increase. As in the first exemplary embodiment, the pull-in voltages of the inner and peripheral cells 2 of the element 3 can be made equivalent by adjusting the distance between the first electrode 7 and the second electrodes 11 of the peripheral cells 2 of the element 3. In such a manner, the durability over long-term driving can be improved without variations in pull-in voltage between the inner and peripheral cells 2 of the element 3.

A fourth exemplary embodiment will be described below. To explain the disclosure, the present exemplary embodiment describes a structure of a CMUT 1 and a method for manufacturing the same. The CMUT 1 according to the present exemplary embodiment will be described with reference to FIGS. 10, 11, 14, and 15. In the present exemplary embodiment, stress on first electrical wiring 13 arranged on vibrating membranes 17 will be described.

The structure and manufacturing method of the CMUT 1 according to the present exemplary embodiment are basically the same as those of the first and second exemplary embodiments. As described above, to improve the durability of the CMUT 1 over long-term driving, it is desirable that the stress on the first electrical wiring 13 arranged on the vibrating membranes 17 of the peripheral cells 2 of the element 3 is reduced. For that purpose, it is desirable that the width 18 of the first electrical wiring 13 arranged on the vibrating membranes 17 of the peripheral cells 2 of the element 3 is made smaller than in the inner cells 2. As described in the first exemplary embodiment, the durability over long-term driving can be improved with the width 18 of the first electrical wiring 13 arranged on the vibrating membranes 17 of the inner cells 2 of the element 3 being set to 5 μm and the width 18 of the first electrical wiring 13 in the peripheral cells 2 of the element 3 being set to 2 μm. As illustrated in FIG. 10 of the first exemplary embodiment, such settings make the pull-in voltage of the peripheral cells 2 of the element 3 lower than that of the inner cells 2 of the element 3. The pull-in voltages of the inner and peripheral cells 2 of the element 3 can be made equivalent by adjusting the height of the gaps 9 in the peripheral cells 2 of the element 3 to 143 nm as illustrated in FIG. 11. The durability of the CMUT 1 over long-term driving can thereby be improved without variations in pull-in voltage between the inner and peripheral cells 2 of the element 3.

The thickness 19 of the first electrical wiring 13 arranged on the vibrating membranes 17 of the peripheral cells 2 of the element 3 can be reduced. As described in the second exemplary embodiment, the durability over long-term driving can be improved with the thickness 19 of the first electrical wiring 13 arranged on the vibrating membranes 17 of the inner cells 2 of the element 3 being set to 100 nm and the thickness 19 of the first electrical wiring 13 of the peripheral cells 2 of the element 3 being set to 50 nm. The thickness of the second electrodes 11 can further be reduced as well as the thickness 19 of the first electrical wiring 13 arranged on the vibrating membranes 17 of the peripheral cells 2 of the element 3. As illustrated in FIG. 14 of the second exemplary embodiment, such settings make the pull-in voltage of the peripheral cells 2 of the element 3 higher than that of the inner cells 2 of the element 3. The pull-in voltages of the inner and peripheral cells 2 of the element 3 can be made equivalent by adjusting the height of the gaps 9 in the peripheral cells 2 of the element 3 to 138 nm as illustrated in FIG. 15. The durability of the CMUT 1 over long-term driving can thereby be improved without variations in pull-in voltage between the inner and peripheral cells 2 of the element 3.

As described above, a CMUT according to an exemplary embodiment is configured so that the wiring electrically connecting the electrodes of cells has different structures between the periphery and inner side of an element included in the CMUT. This can solve issues resulting from a difference in the amplitude of the vibrating membranes of the cells between the periphery and inner side of the element of the CMUT.

While the disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2018-143723, filed Jul. 31, 2018, which is hereby incorporated by reference herein in its entirety.

What is claimed is:

1. A capacitive transducer comprising an element including a plurality of cells,
wherein the cells each include a first electrode and a vibrating membrane including a second electrode opposed to the first electrode via a gap,
wherein the second electrode of one of the plurality of cells is electrically connected to the second electrode of at least one adjoining cell by first electrical wiring, and
wherein the first electrical wiring over the gap of a first cell provided on a periphery of the element among the plurality of cells has a structure different from that of the first electrical wiring over the gap of a second cell provided on an inner side of the element than the first cell is.

2. The capacitive transducer according to claim 1, wherein the first electrical wiring over the gap of the first cell provided on the periphery of the element among the plurality of cells has a width different from that of the first electrical wiring over the gap of the second cell provided on the inner side of the element than the first cell is.

3. The capacitive transducer according to claim 1, wherein the first electrical wiring over the gap of the first cell provided on the periphery of the element among the plurality of cells has a width greater than that of the first electrical wiring over the gap of the second cell provided on the inner side of the element than the first cell is.

4. The capacitive transducer according to claim 1, wherein the first electrical wiring over the gap of the first cell provided on the periphery of the element among the plurality of cells has a thickness different from that of the first electrical wiring over the gap of the second cell provided on the inner side of the element than the first cell is.

5. The capacitive transducer according to claim 1, wherein the first electrical wiring over the gap of the first cell provided on the periphery of the element among the plurality of cells has a thickness greater than that of the first electrical wiring over the gap of the second cell provided on the inner side of the element than the first cell is.

6. The capacitive transducer according to claim 1, wherein the second electrode of the first cell provided on the periphery of the element among the plurality of cells has a thickness different from that of the second electrode of the second cell provided on the inner side of the element than the first cell is.

7. The capacitive transducer according to claim 1, wherein the second electrode of the first cell provided on the periphery of the element among the plurality of cells has a thickness greater than that of the second electrode of the second cell provided on the inner side of the element than the first cell is.

8. The capacitive transducer according to claim 1, wherein the first electrical wiring over the gap of the first cell provided on the periphery of the element among the plurality of cells has a Young's modulus different from that of the first electrical wiring over the gap of the second cell provided on the inner side of the element than the first cell is.

9. The capacitive transducer according to claim 1, wherein the first electrical wiring over the gap of the first cell provided on the periphery of the element among the plurality of cells has a Young's modulus higher than that of the first electrical wiring over the gap of the second cell provided on the inner side of the element than the first cell is.

10. The capacitive transducer according to claim 1, wherein the second electrode of the first cell provided on the periphery of the element among the plurality of cells has a Young's modulus different from that of the second electrode of the second cell provided on the inner side of the element than the first cell is.

11. The capacitive transducer according to claim 1, wherein the second electrode of the first cell provided on the periphery of the element among the plurality of cells has a Young's modulus higher than that of the second electrode of the second cell provided on the inner side of the element than the first cell is.

12. The capacitive transducer according to claim 1, wherein the first electrical wiring over the gap of the first cell provided on the periphery of the element among the plurality of cells is made of a material different from that of the first electrical wiring over the gap of the second cell provided on the inner side of the element than the first cell is.

13. The capacitive transducer according to claim 1, wherein the first electrical wiring over the gap of the first cell provided on the periphery of the element among the plurality of cells has a fatigue limit higher than that of the first electrical wiring over the gap of the second cell provided on the inner side of the element than the first cell is.

14. The capacitive transducer according to claim 1, wherein the first electrical wiring over the gap of the first cell provided on the periphery of the element among the plurality of cells has a stress different from that of the first electrical wiring over the gap of the second cell provided on the inner side of the element than the first cell is.

15. The capacitive transducer according to claim 1, wherein the first electrical wiring over the gap of the first cell provided on the periphery of the element among the plurality of cells has a stress higher than that of the first electrical wiring over the gap of the second cell provided on the inner side of the element than the first cell is.

16. The capacitive transducer according to claim 1, wherein the first cell provided on the periphery of the element has substantially a same pull-in voltage as that of the second cell provided on the inner side of the element than the first cell is.

17. An ultrasonic probe comprising:
the capacitive transducer according to claim 1;
a detection unit configured to detect an ultrasonic wave generated by irradiation of a subject with an ultrasonic wave and output a signal; and
an acquisition unit configured to obtain information about the subject based on the signal.

18. A photoacoustic apparatus comprising:
the capacitive transducer according to claim 1;
a detection unit configured to detect an acoustic wave generated by irradiation of a subject with light and output a signal; and
an acquisition unit configured to obtain information about the subject based on the signal.
